(19) United States
(12) Patent Application Publication
(10) Pub. No.: US 2009/0122335 A1
(43) Pub. Date: May 14, 2009

(54) IMAGE EDITING APPARATUS

(75) Inventor: Shinji KAWASAKI, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/250,873

(22) Filed: Oct. 14, 2008

(30) Foreign Application Priority Data
Nov. 13, 2007 (JP) 2007-294490

(51) Int. Cl. G06F 3/12

(52) U.S. Cl. 358/1.15

(57) ABSTRACT

An image editing apparatus includes a storage unit arranged to store, along with image data, index data as an index of the image data. In the index data, a character string extracted from the image data and area information indicating an area that includes the character string are recorded in association with each other. The image editing apparatus also includes a filter setting unit arranged to set filter setting information including information regarding a filter pattern that is applied to the area, and an image editing unit arranged to edit the image data based on the area information and the filter setting information.

### CROSS-REFERENCE TO RELATED APPLICATION

This application claims priority under 35 U.S.C. 119 to Japanese Patent Application No. 2007-294490, filed on Nov. 13, 2007, which application is hereby incorporated by reference in its entirety.

### BACKGROUND OF THE INVENTION

1. Field of the Invention

The present invention relates to an image editing apparatus that performs a filtering process on a prescribed area of image data.

2. Description of the Related Art

Recently, a document management system that manages in-house documents and/or external documents is being increasingly used in businesses. The document management system manages not only electronic data such as electronic mails (e-mails) and web pages, but also image data that is generated by scanning paper-based documents using a scanner. The data managed by the document management system often includes a substantial amount of confidential information, such as individual information (i.e., personal data), technical information, and monetary information.

When image data that includes confidential information is output by printing or facsimile transmission, the confidential information could be leaked to outsiders. In order to prevent the confidential information from being leaked to the outsiders, a filling process is performed in which an area displaying the confidential information of the image data is filled with black before the image data is output.

Furthermore, some image data is output in a state where important information displayed in the image data is highlighted. In such a case, a highlighting process is performed in which an area displaying the important information is framed or shaded.

For example, a conventional apparatus performs the filling process and the highlighting process (hereinafter, referred to as a “filtering process”) on image data.

In response to user operations, the conventional apparatus provides, on original document image data, a masking object (an edit area) arranged to specify an area on which the filtering process will be performed. Then, masking object template data including various pieces of data, such as position information of the masking object, is created and registered in template management data. In a conventional image editing apparatus, the masking object template data is inserted into an extension header portion of the original document image data, and edited original document image data is created.

As described above, the conventional image editing apparatus registers the masking object template data that specifies the area on which the filtering process will be performed in the template management data. Now, an example will be described in which the filtering process is performed on another image data of a format that is the same as that of the original document image data. In such a case, by using the masking object template data registered in the template management data, the user specifies the area on which the filtering process will be performed. Thus, the user can eliminate the trouble of specifying the area for the filtering process for each document.

However, in the case of performing the filtering process using the conventional image editing apparatus, the user needs to display, in an overlapped state, (1) the original document image data on which the filtering process will be performed, and (2) the masking object template data registered in the template management data. In the above-described operation, the user needs to search for the masking object template data that is suitable for the filtering process.

When performing the filtering process on image data that is created in another format, the user still needs to specify the area for the filtering process in order to create the masking object template data.

### SUMMARY OF THE INVENTION

In order to overcome the problems described above, preferred embodiments of the present invention provide an image editing apparatus that allows a user to easily perform a filtering process on image data.

A preferred embodiment of the present invention provides (1) a storage unit arranged to store, along with image data, index data as an index of the image data, in which index data a character string extracted from the image data and area information indicating an area that includes the character string are recorded in association with each other, (2) a filter setting unit arranged to set filter setting information including information regarding a filter pattern that is applied to the area, and (3) an image editing unit arranged to edit the image data based on the area information and the filter setting information.

According to a further preferred embodiment of the present invention, the filter patterns include a filter that applies a highlighting display to the area.

According to a further preferred embodiment of the present invention, the filter patterns include a filter that applies a filling display to the area.

A further preferred embodiment of the present invention provides a preview creating unit arranged to create a preview that confirms the image data that is edited based on the filter setting information.

According to a further preferred embodiment of the present invention, the image data of the preview displays a boundary line that indicates an area in which a displaying state can be changed. This boundary line is based on the area information.

In the image editing apparatus according to preferred embodiments of the present invention, the area that includes the character string extracted as the index of the image data can be specified as the area on which the filtering process will be performed in the image data. Thus, without specifying the area for the filtering process, the user can set the displaying state of the area on which the filtering process will be performed. Accordingly, in the image editing apparatus according to preferred embodiments of the present invention, the user operations in the filtering process of the image data can be simplified.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates a document management system including a configuration of a network Multi Function Peripheral (MFP) according to a preferred embodiment of the present invention.

FIG. 2 illustrates an example of document image data.

FIG. 3 illustrates index data created based on the document image data of FIG. 2.

FIG. 4 illustrates an example of filter setting data.

FIG. 5 is a flowchart of an operation of the network MFP.

FIG. 6 illustrates a setting interface displayed at the time of changing filter settings.

FIG. 7 illustrates a setting interface displayed after the filter settings are changed.

### DETAILED DESCRIPTION OF PREFERRED EMBODIMENTS

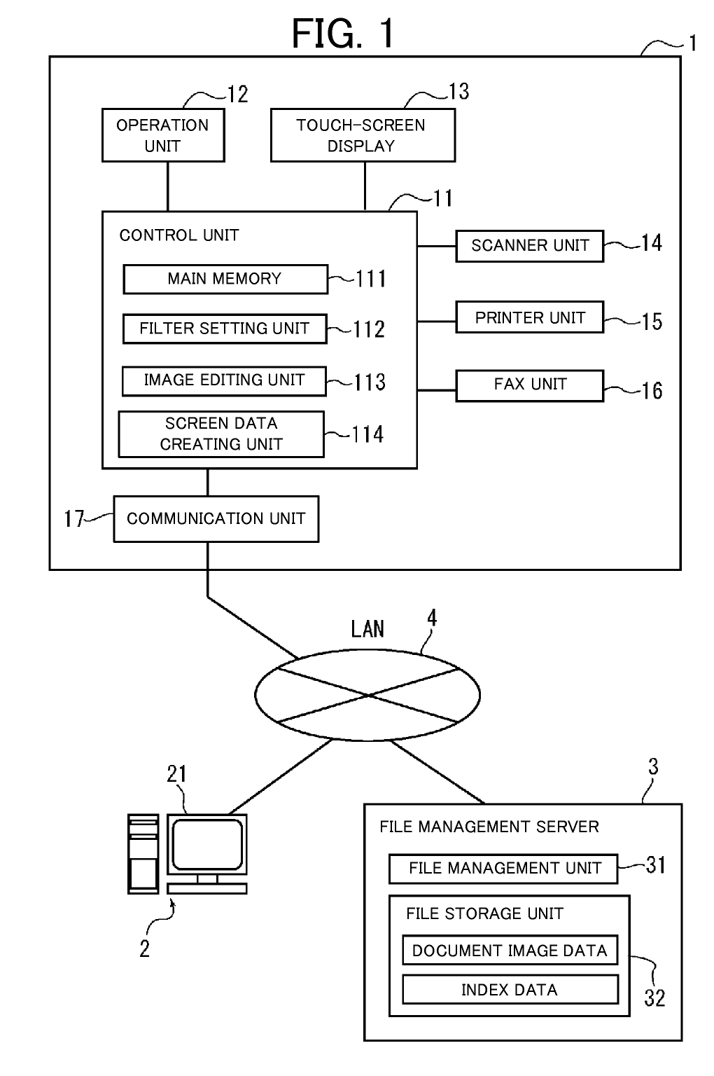

With reference to the drawings, preferred embodiments of the present invention will now be described. A network MFP will be described as an example of an image editing apparatus of a preferred embodiment of the present invention. FIG. 1 illustrates a document management system including a configuration of the network MFP according to a preferred embodiment of the present invention.

In the document management system of FIG. 1, a network MFP 1, a personal computer (PC) 2, and a file management server 3 are connected through a Local Area Network (LAN) 4. The LAN 4 preferably includes a router (not illustrated) arranged to connect with the Internet, other LANs, or the like.

The network MFP 1 is a multi functional apparatus that preferably includes a copier function, a printer function, a scanner function, a FAX function, and/or an electronic mail (e-mail) function, etc. By directly operating the network MFP 1, a user can output document image data managed by the file management server 3, in various formats such as printing, FAX transmission, e-mail transmission, etc. Moreover, by operating the PC 2 connected with the LAN 4, the user can output the document image data from the network MFP 1.

The document image data output from the network MFP 1 of FIG. 1 and index data will be described.

The document image data corresponds to electronic data that is created by scanning a paper-based document by a scanner. The index data corresponds to data that is created with respect to each document image data, and that records an index for searching each document image data. The index data is described by using an eXtensible Markup Language (XML), or the like. The document image data and the index data are associated with each other by, for example, matching a character string other than the extension of a file name, and are managed in the file management server 3.

For example, the index data is created in the following process. First, text data is created from the document image data in an optical character recognizing process, or the like. Then, based on a pre-set attribution name of attribution data and extraction conditions of the attribution name, a character string extracted from the text data is set as the attribution data. The character string included in the attribution data is set as the attribution name. An area that includes the character string extracted as the attribution data is specified as an index area. The attribution data and area information indicating the index area are associated, and thus, the index data is created.

Alternatively, the user may specify the area from which the character string is extracted in the document image data. In such a case, the area specified by the user is set as the index area, and the character string extracted from the user-specified area is set as the attribution data.

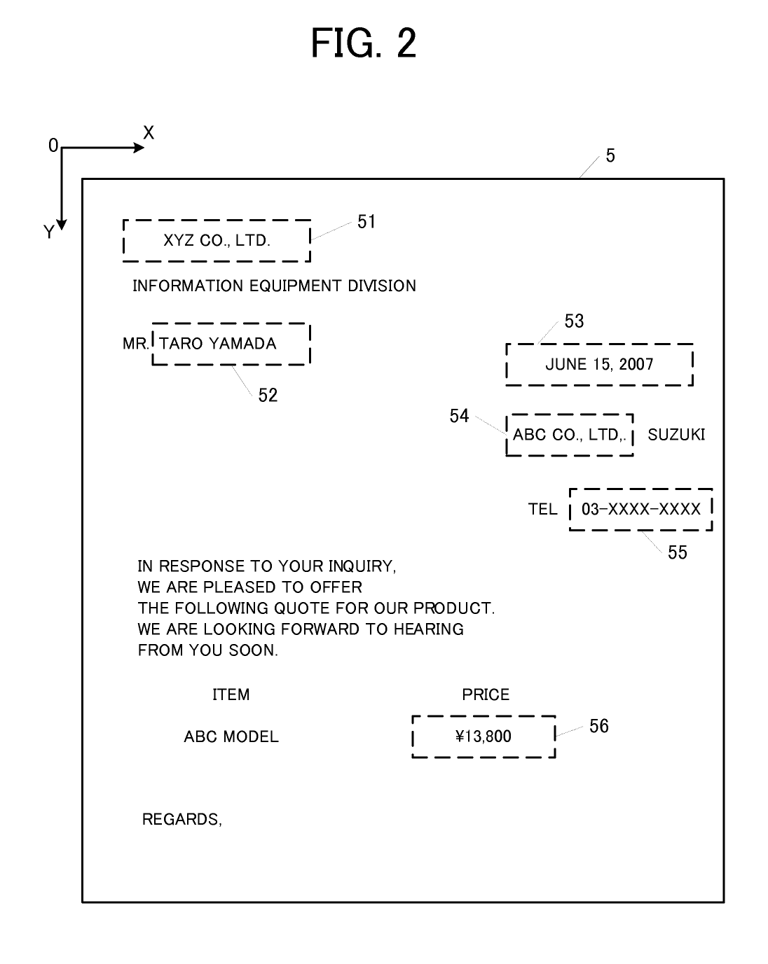

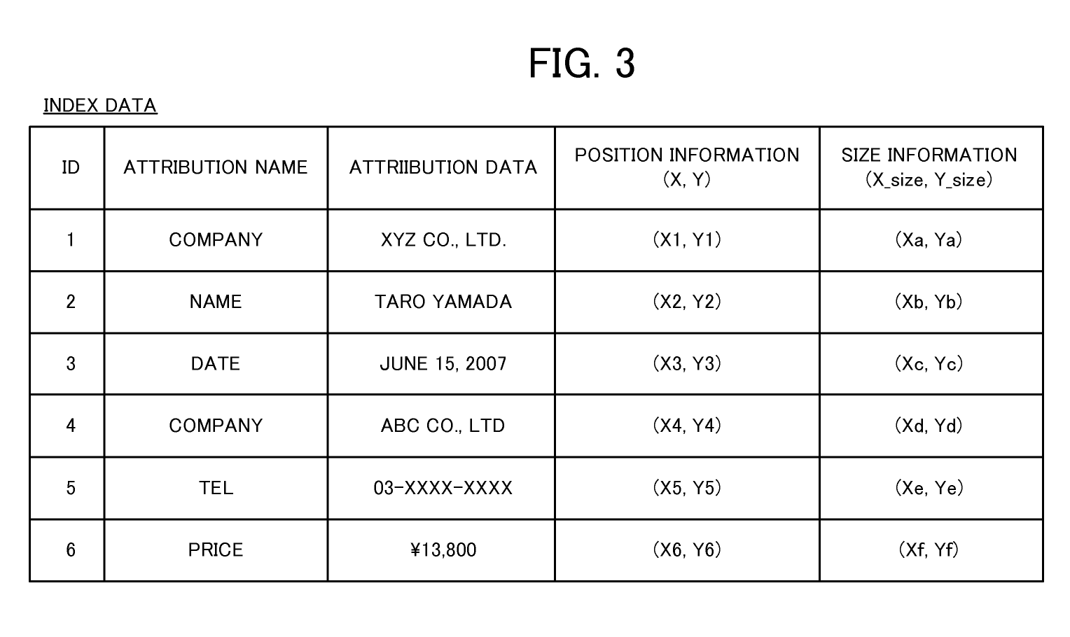

A specific example of the index data will be described with reference to FIGS. 2 and 3. FIG. 2 illustrates an example of the document image data. FIG. 3 illustrates the index data in a table format, which is created based on the document image data of FIG. 2.

In document image data 5 of FIG. 2, areas surrounded by dashed line are index areas 51 through 56. The index areas 51 through 56 display character strings that are extracted as the attribution data from the document image data 5. The character strings in the index areas 51 through 56 are registered as the attribution data in the index data.

Index data 6 of FIG. 3 includes an ID, an attribution name, attribution data, position information, size information, etc. The ID is a number specifically allotted with respect to each character string extracted as the attribution data from the document image data 5. The attribution name is an item such as a “name” and an “address”. The attribution data corresponds to the attribution name, which is the character string that is included in the respective index areas 51 through 56 as described above. More specifically, the attribution data of IDs 1 through 6 corresponds to the character string included in each of the index areas 51 through 56.

The position information and the size information are the area information that is used to specify the index area of the document image data. The position information indicates a position of the top at the upper left of the index area. As illustrated in FIG. 2, assuming that the upper-left top of the document image data 5 is the origin, a rightward direction is an x-axis direction, and a downward direction is a Y-axis direction, the position information can be represented in an XY coordinate system. The size information indicates each length in the X-axis direction and in the Y-axis direction of the index area. Pixels are used as measurement units of the XY coordinate system. The index areas 51 through 56 preferably have a rectangular or substantially rectangular shape in FIG. 2, but may have a circular shape, an oval shape, or any other desired shape, for example.

As illustrated in FIG. 2, in most cases, the character string extracted as the attribution data from the document image data 5 is confidential information such as an individual name, a company name, monetary information, etc. In other words, the index data 6 includes confidential information and information indicating an area displaying the confidential information. The above-described information may be important information. For example, an individual name and a company name are the important information from which a creation source of the document image data can be specified. By using the index data including the above-described features, the network MFP 1 specifies the area on which the filtering process will be performed in the document image data. Thus, the user can execute the filtering process without specifying the area on which the filtering process will be performed.

Next, a configuration of the network MFP 1 of FIG. 1 will be described. The network MFP 1 includes a control unit 11, an operation unit 12, a touch-screen display 13, a scanner unit 14, a printer unit 15, a FAX unit 16, and a communication unit 17.

The control unit preferably includes a main memory 111, a filter setting unit 112, an image editing unit 113, a screen data creating unit 114 and a micro processor (not illustrated). The micro processor and the main memory 111 control the entire network MFP 1. The main memory 111, the filter setting unit 112, the image editing unit 113, and the screen data creating unit 114 will be described in detail later.

The operation unit 12 preferably includes a hardware key arranged to input various instructions to the network MFP 1, or the like. The touch-screen display 13 preferably displays information regarding the network MFP 1 and various operation menus. By using the operation unit 12 and the touch-screen display 13, the user can perform various operations of the network MFP 1.

The scanner unit 14 scans paper-based documents placed on an Auto Document Feeder (not illustrated), or the like, and outputs the scanned data as the document image data. The document image data output by the scanner unit 14 is managed by the file management server 3 after the corresponding index data is created.

The printer unit 15 prints the data transmitted from the PC 2, or the like, on a recording paper in accordance with various setting conditions. The copier function of the network MFP 1 is implemented by cooperation of the control unit 11, the scanner unit 14, and the printer unit 15.

The FAX unit 16 performs facsimile communication via a Public Switched Telephone Network (not illustrated), for example. The communication unit 17 transmits and/or receives data by using a protocol such as a Transmission Control Protocol/Internet Protocol (TCP/IP) among each computer connected with the LAN 4 or with the Internet.

Next, each function unit of the control unit 11 will be described. The main memory 111 includes a Random Access Memory (RAM), or the like, and stores the document image data and index data transmitted from the file management server 3 or the PC 2.

The filter setting unit 112 creates filter setting data by using the index data. The area information indicating the index area of the document image data and information indicating a filter pattern of each index area are recorded in the filter setting data.

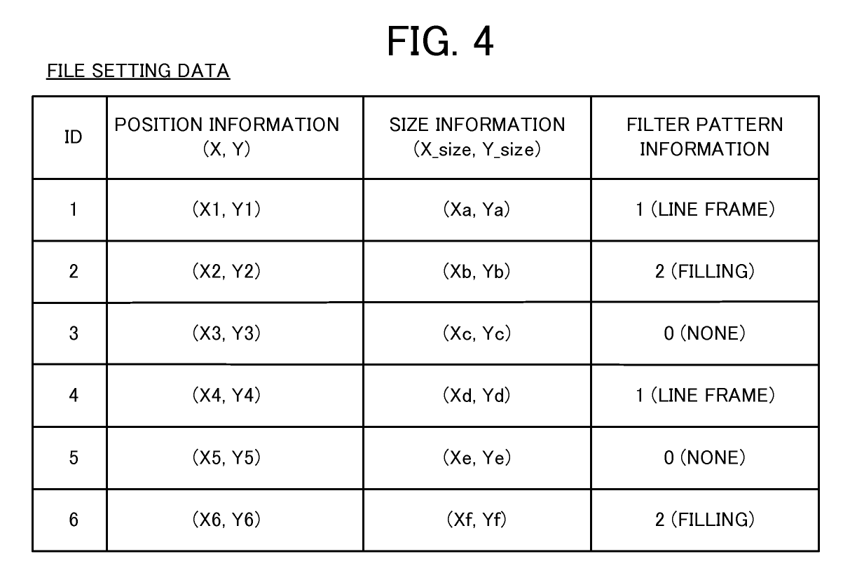

FIG. 4 illustrates an example of the filter setting data. Filter setting data 7 illustrated in FIG. 4 is created based on the index data 6 (refer to FIG. 3). In the filter setting data 7, each ID corresponds to the respective IDs of the index data 6. Position information and size information correspond to the position information and the size information of the index data 6. The filter pattern information is numeric information indicating the filter pattern of the index area that corresponds to each ID.

As illustrated in FIG. 4, any one of the numeric values “0”, “1”, or “2” is set to the filter pattern information. The filter pattern information “0” indicates that the filtering process will not be performed on the index area. The filter pattern information “1” indicates that when the index area is framed by a line, a highlighting process will be performed. The filter pattern information “2” indicates that a filling process will be performed on the index area.

In FIG. 4, the filter pattern information of “ID 1” and “ID 4” is “1”. In this case, the highlighting process will be performed on the index areas 51 and 54 (refer to FIG. 2). The filter pattern information of “ID 2” and “ID 6” is “2”. In this case, the filling process will be performed on the index areas 52 and 56 (refer to FIG. 2). The filter pattern information of “ID 3” and “ID 5” is “0”. In this case, the filtering process will not be performed on the index areas 53 and 55 (refer to FIG. 2).

The image editing unit 113 changes a displaying state of the index area of the document image data and creates output data based on the filter setting data.

The screen data creating unit 114 creates screen data for displaying, on a monitor 21 of the PC 2, a user interface (hereinafter, referred to as a “setting interface”) arranged to output settings of the document image data. The screen data is created based on the document image data 5, the index data 6, and the filter setting data 7.

Next, the file management server 3 will be described. The file management server 3 preferably includes a file management unit 31 and a file storage unit 32. In response to a request from each computer connected with the LAN 4, the file management unit 31 transmits the document image data and the index data, or searches for the document image data, or the like. The file storage unit 32 preferably includes a hard disc device, etc., and stores the document image data and the index data.

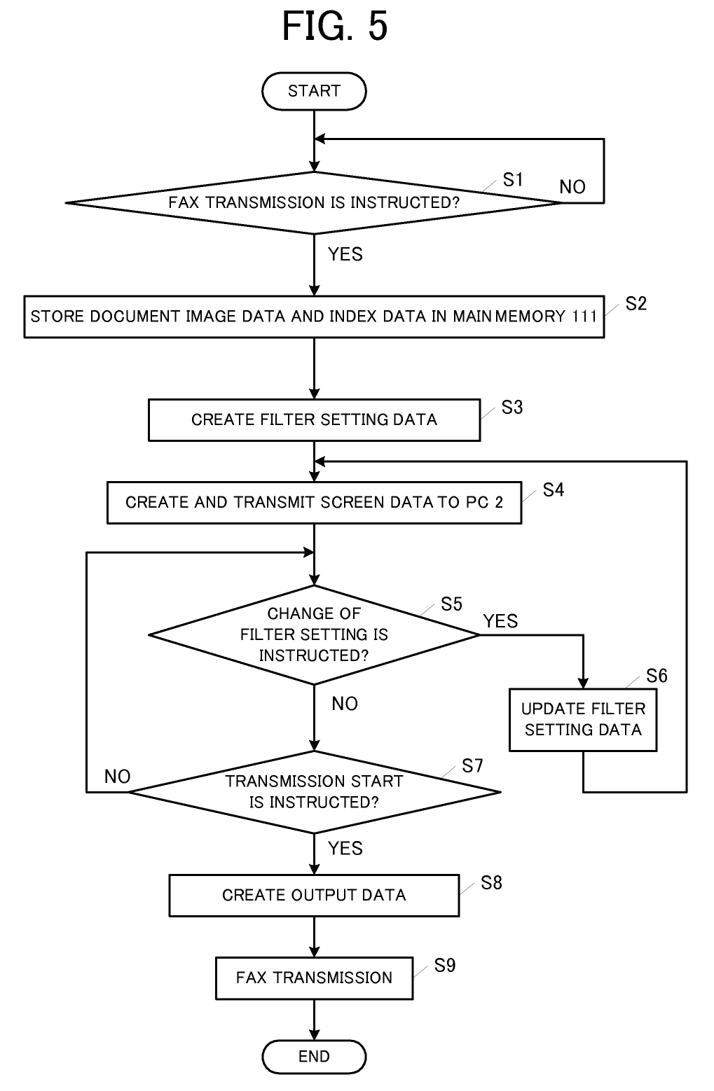

With reference to FIG. 5, an operation performed when the network MFP 1 having the above-described configuration outputs the document image data will be described. FIG. 5 is a flowchart illustrating an operation in which the network MFP 1 transmits the document image data via facsimile.

The user first instructs, preferably by operating the PC 2, the network MFP 1 to transmit the document image data via facsimile. Accompanying the instruction for facsimile transmission, the file name of the document image data and the file name of the index data to be transmitted via facsimile are transmitted from the PC 2 to the network MFP 1.

When the instruction for facsimile transmission is received (“Yes” in step S1), the network MFP 1 accesses the file management server 3 in order to acquire the document image data and index data for facsimile transmission. The network MFP 1 stores the acquired document image data and index data in the main memory 111 (step S2). When the file name of the index data is specified, the network MFP 1 determines that it is necessary to perform the filtering process on the document image data.

The filter setting unit 112 references the index data and creates the filter setting data (step S3). When the filter setting data is created, all of the filter pattern information of each ID indicates “0”.

Then, the screen data creating unit 114 preferably uses the document image data, index data and filter setting data to create the screen data, and transmits the created screen data to the PC 2 (step S4). The PC 2 receives the screen data and displays the setting interface on the monitor 21. The user uses the setting interface to perform the output settings of the document image data.

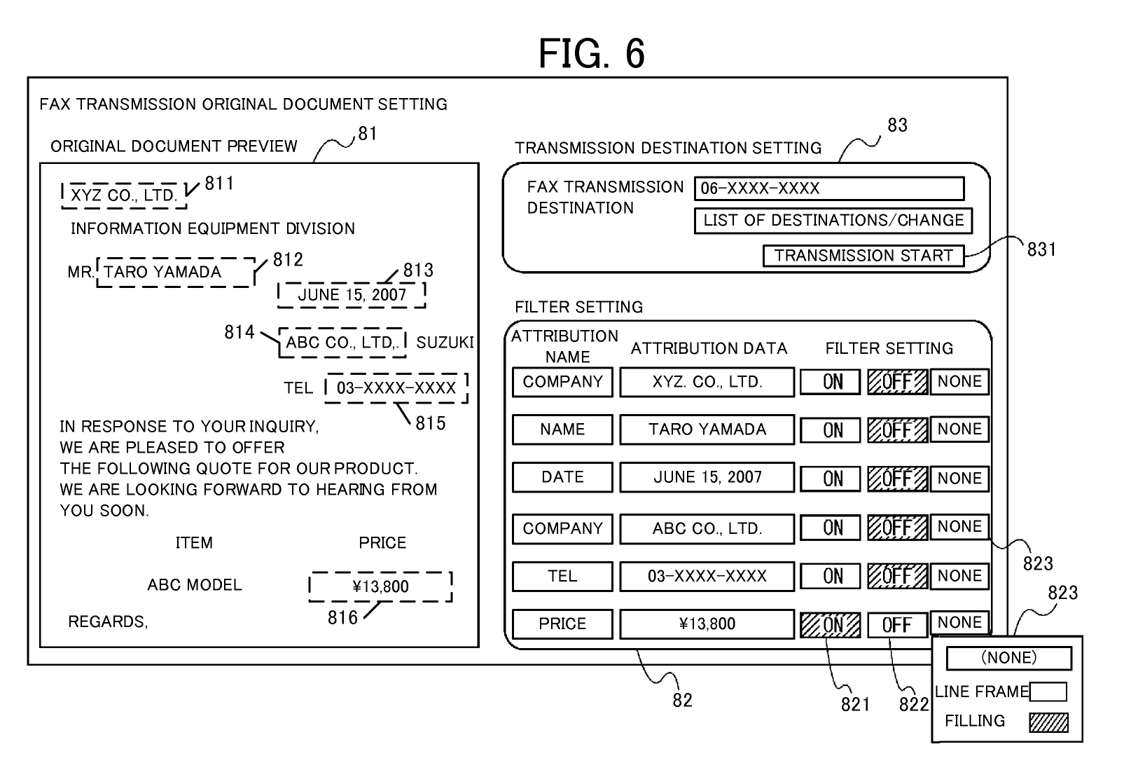

The setting interface displayed at the PC 2 will be described. FIG. 6 illustrates the setting interface displayed at the time of outputting the document image data 5. In FIG. 6, for illustration purposes, shading (hashing) is used in place of a solid black box, such as would be included in the actual interface.

In FIG. 6, an original document preview unit 81 displays a preview of the document image data 5 edited based on the filter setting data. Areas 811 through 816 framed by dashed-line indicate an area on which the filtering process can be performed. The areas 811 through 816 respectively correspond to the index areas 51 through 56 illustrated in FIG. 2.

A filter setting display unit 82 displays the attribution name and attribution data of each ID stored in the index data 6. A filter validating button 821, a filter invalidating button 822, and a filter selection menu 823 are provided with respect to each displayed attribution data. The filtering process is not always performed on all the index areas, and thus, the settings of the filtering process can be performed with respect to each index area.

The filter validating button 821 is a button that validates the settings of the filtering process in the corresponding index area. That is, when the filter validating button 821 is pressed, the filter selection menu 823 becomes usable. The filter validating button 821 displayed in black indicates that the corresponding filter selection menu 823 can be used. The filter invalidating button 822 is a button that invalidates the settings of the filtering process in the corresponding index area. The filter invalidating button 822 displayed in black indicates that the filtering process will not be performed in the corresponding index area, and that the corresponding selection menu 823 cannot be used.

As illustrated in FIG. 6, either one of the filter validating button 821 and the filter invalidating button 822 is displayed in black. In the setting interface in an initial state, all of the filter invalidating buttons 822 are displayed in black. That is because the screen data is created based on the filter setting data having all of the filter pattern information indicating “0”.

The filter selection menu 823 displays in a pull-down menu a filter pattern that can be set for each index area. As illustrated in FIG. 6, in the filter selection menu 823 of the attribution data “¥13,800”, the filter patterns that can be selected by the user are displayed. A title of the filter selection menu 823 includes the filter pattern that is set based on the user operation or the filter setting data.

The “none” displayed in the filter selection menu 823 corresponds to the filter pattern information “0”, and indicates that the filter setting will be invalidated. When “none” is selected, the filter invalidating button 822 is displayed in black. The “line frame” corresponds to the filter pattern information “1”, and indicates that the highlighting process using a line frame will be performed. The “filling” corresponds to the filter pattern information “2”, and indicates that the filling process will be performed.

At a FAX setting unit 83, a telephone number of a facsimile transmission destination and a transmission start button 831, or the like, are displayed. At the FAX setting unit 83, buttons used to set whether or not to attach a cover letter or to set whether or not to confirm reception may be displayed.

Now, FIG. 5 will be described again. The user checks the original document preview unit 81, and determines the index area (attribution data) on which the filtering process will be performed. The user presses the filter validating button 821 that corresponds to the index area (attribution data) on which the filtering process will be performed. Then, the user selects the filter pattern from the filter selection menu 823.

The PC 2 transmits the ID of the index area (attribution data) of which the filter setting has been changed and the filter pattern information to the network MFP 1, so as to instruct to change the filter setting. When the instruction for changing the filter setting is received (“Yes” in step S5), the filter setting unit 112 updates the filter setting data based on the received ID and filter pattern information (step S6).

The screen data creating unit 114 creates the screen data based on the updated filter setting data, and transmits the created screen data to the PC 2 (step S4). The network MFP 1 repeats the above-described process until the instruction for starting facsimile transmission is received (“Yes” in step S7).

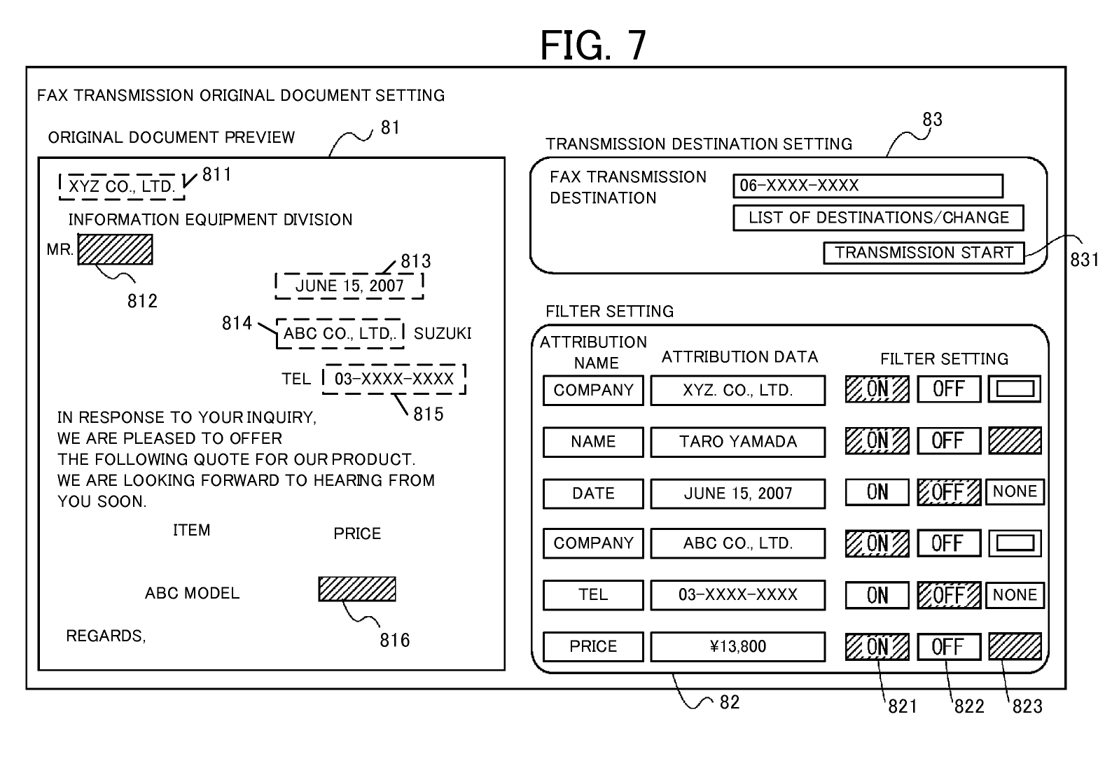

FIG. 7 illustrates an example of the setting interface displayed after the filter setting is changed. Similarly to FIG. 6, FIG. 7 also uses the shading in place of black. A value of the filter pattern information in the filter setting data 7 (refer to FIG. 4) corresponds to the settings of the filtering process of the filter setting display unit 82 illustrated in FIG. 7.

The filter settings of the attribution data “XYZ Co., Ltd.” and of the attribution data “ABC Co., Ltd.” are set to be “line frame” in the filter setting display unit 82 of FIG. 7. Accordingly, by displaying an outer frame of the areas 811 and 814 in full line, each index area is highlighted. The filter settings of the attribution data “Taro Yamada” and of “¥13,800” are set to be “filling”. Accordingly, the areas 812 and 816 are filled with black, and the attribution data in each index area is hidden. The filter settings of the attribution data “Jun. 15, 2007” and of “Tel” are set to be “invalidated” (“none”). Accordingly, the areas 812 and 816 remain surrounded by a dashed-line.

At this time, the screen data creating unit 114 creates the image data for preview without directly editing the document image data 5. For example, by placing a rectangular graphic object displayed in black on the document image data 5, the screen data creating unit 114 can create the document image data for preview.

After checking the updated setting interface, the user presses the transmission start button 831. The PC 2 instructs the network MFP 1 to start facsimile transmission. Having received the instruction for the start of the facsimile transmission (“Yes” in step S7), the image editing unit 113 creates output data based on the filter setting data (step S8). At this time, the dashed-line surrounding the areas 813 and 815 (refer to FIG. 7) is not reflected (displayed) in the output data. Then, the FAX unit 16 transmits via facsimile the created output data to the specified transmission destination (step S9). Thus, the facsimile transmission process of the document image data is completed.

As described above, the network MFP 1 according to the preferred embodiments of the present invention sets the area on which the filtering process can be performed in the document image data, by using the index data in which the attribution data and the area information indicating the index area that includes the attribution data are stored. Therefore, when setting the filtering process, the user only has to set the filter pattern for the set area. Accordingly, by using the network MFP 1 according to a preferred embodiment of the present invention, the operations performed by the user in the filtering process in the document image data can be simplified.

In the present preferred embodiment, the example has been described in which the network MFP 1 transmits the document image data via facsimile, however, the present invention is not limited to the above-described example. For example, when printing the document image data or when transmitting the data via e-mail, the above-described process can be applied. In such a case, the display of the FAX setting unit 83 illustrated in FIGS. 6 and 7 may be replaced with an interface arranged for printing or for e-mail transmission.

In the present preferred embodiment, the example has been described in which the user operates the PC 2 to output the document image data, however, the present invention is not limited to the above-described example. The user may directly operate the network MFP 1 to set the filtering process of the document image data. In such a case, the setting interface illustrated in FIGS. 6 and 7 may be displayed on the touch-screen display 13.

In the present preferred embodiment, the example has been described in which the network MFP 1 acquires, from the file management server 3, the document image data and the index data to be transmitted via facsimile, however, the present invention is not limited to the above-described example. For example, the PC 2 may store the document image data and the index data. In such a case, when the user operates the PC 2 to instruct the network MFP 1 to perform facsimile transmission, the document image data and the index data are transmitted from the PC 2 to the network MFP 1.

In the present preferred embodiment, the example of the highlighting process using the line frame and the filling process using black has been described, however, the present invention is not limited to the above-described example. For example, in the highlighting process, the display color may be inverted. In the filling process, colors other than black may be used.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image editing apparatus comprising:
a storage unit arranged to store image data and index data, wherein:
the index data is an index of the image data;
the index data includes both a character string extracted from the image data and area information indicating an area that includes the character string; and
the index data and the character string are recorded in association with each other; and
the image editing apparatus further comprising:
a filter setting unit arranged to set filter setting information including information regarding a filter pattern that is applied to the area; and
an image editing unit arranged to edit the image data based on the area information and the filter setting information.

2. The image editing apparatus according to claim 1, wherein the filter patterns include a filter that applies a highlighting display to the area.

3. The image editing apparatus according to claim 1, wherein the filter patterns include a filter that applies a filling display to the area.

4. The image editing apparatus according to claim 1 further comprising:
a preview creating unit arranged to create a preview to enable a user to confirm the image data that is edited based on the filter setting information.

5. The image editing apparatus according to claim 2 further comprising:
a preview creating unit arranged to create a preview to enable a user to confirm the image data that is edited based on the filter setting information.

6. The image editing apparatus according to claim 3 further comprising:
a preview creating unit arranged to create a preview to enable a user to confirm the image data that is edited based on the filter setting information.

7. The image editing apparatus according to claim 4, wherein, in the image data displayed in the preview, a boundary line that indicates an area in which a displaying state can be changed is displayed based on the area information.

8. The image editing apparatus according to claim 5, wherein, in the image data displayed in the preview, a boundary line that indicates an area in which a displaying state can be changed is displayed based on the area information.

9. The image editing apparatus according to claim 6, wherein, in the image data displayed in the preview, a boundary line that indicates an area in which a displaying state can be changed is displayed based on the area information.
